(19) United States
(12) Patent Application Publication
(10) Pub. No.: US 2025/0370173 A1
(43) Pub. Date: Dec. 4, 2025

(54) ULTRA-SPECTRALLY SELECTIVE TERAHERTZ BAND STOP REFLECTOR

(71) Applicant: University of Central Florida Research Foundation, Inc., Orlando, FL (US)

(72) Inventors: Anthony C. Terracciano, Orlando, FL (US); Christopher Arose, Orlando, FL (US); Subith Vasu, Orlando, FL (US)

(21) Appl. No.: 19/179,532

(22) Filed: Apr. 15, 2025

Related U.S. Application Data
(63) Continuation of application No. 17/456,493, filed on Nov. 24, 2021, now Pat. No. 12,276,606.
(60) Provisional application No. 63/142,078, filed on Jan. 27, 2021.

(51) Int. Cl. G02B 5/20; G02B 5/26

(52) U.S. Cl. CPC G02B 5/204; G02B 5/208; G02B 5/26

(57) ABSTRACT

Described herein relates to an apparatus and method for controlling electromagnetic wave attenuation. The apparatus may include a first layer comprising a substrate, a top coating, and a bottom coating. The top coating can be an absorber layer having high conductivity and/or including a conductive region surrounded by an absence region. The bottom coating may be a backplane layer having high conductivity. The apparatus can further include a plurality of such layers, where a top layer may include an absorber layer with an absence region having a first area, and/or a bottom layer may include an absorber layer with an absence region having a second area. Additionally, the first area may be greater than the second area, enabling a tuning capacity for attenuation. Furthermore, the conductive regions can be patterned in a consistent arrangement to achieve impedance matching and/or spectral selectivity across incident electromagnetic frequencies.

### CROSS-REFERENCE TO RELATED APPLICATIONS

This Nonprovisional Patent Application is a continuation of and claims the benefit of and priority to U.S. Nonprovisional patent application Ser. No. 17/456,493 entitled “ULTRA-SPECTRALLY SELECTIVE TERAHERTZ BAND STOP REFLECTOR” filed Nov. 24, 2021 by the same inventors, which claims the benefit of and prior to U.S. Patent Provisional Application No. 63/142,078 entitled “ULTRA-SPECTRALLY SELECTIVE THZ BAND STOP REFLECTOR” filed Jan. 27, 2021 by the same inventors, all of which are incorporated herein by reference, in their entireties, for all purposes.

### FEDERALLY SPONSORED RESEARCH OR DEVELOPMENT

This invention was made with Government support under Agency Contract number D18AP00040 awarded by the Defense Advanced Research Projects Agency (DARPA). The Government has certain rights in this invention.

### BACKGROUND OF THE INVENTION

### 1. Field of the Invention

This invention relates, generally, to a band stop reflector. More specifically, it relates to an ultra-spectrally selective terahertz (THz) band stop reflector.

### 2. Brief Description of the Prior Art

The terahertz (THz) region of the electromagnetic spectrum (0.1 THz to 10 THz; see FIG. 1) has applications in imaging, telecommunications, and spectroscopy. Recent publications have abounded for the filling of the “THz Gap”, with detectors and sources being of high interest [1-3]. With the recent push to close the “THz gap” with sources and detectors that operate in this range, the need will naturally arise for spectral filters and wavelength absorbers to operate within the THz region. For example, many optical designs may be enhanced using selectively resonating cavities, spectrally selective mirrors, and other devices. Spectral filtering has a plethora of applications, from mitigation of unwanted signals and reduction of noise in spectroscopy and detectors to building highly monochromatic laser systems [4-6]. Resonant absorbers are needed to enable wavelength selective thermal detectors, including pyroelectric, thermo-pile, and bolometer types [7]. However, polarization and incident angle insensitivity would be advantageous in waveguide systems, which have not been produced to date.

Attempts have been made to utilize frequency selective surfaces comprising arrays of sub-wavelength resonant structures. Frequency selective surfaces that provide band-stop filtering have taken many forms as applied to radio and infrared (IR) frequencies [8-14]. These surfaces include Salisbury screens, split ring resonators (SRRs), metal patches, and hole arrays in otherwise continuous metal films. Plasmonic resonances are used to create spectrally selective absorbers in films of negligible thickness compared to transverse structure dimensions, which are themselves smaller than the operating wavelength [17-19]. The absorbers may be considered as either as a metamaterial (an engineered surface of negligible thickness comparative to other dimensions) with effective optical constants or as a collection of independent resonators. Geometry and material properties define the resonances. These absorbers can be used to create spectrally selective thermal detectors [20-23] such as pyroelectrics and bolometers. However, the attempts to create absorber designs to date are asymmetric, which causes absorption to depend on polarization and incidence angle [14-16].

Accordingly, what is needed is an ultra-spectrally selective terahertz (THz) band stop reflector that includes absorption bands that are independent of an incidence angle and polarization. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a novel THz band stop reflector includes a substrate having a top surface opposite a bottom surface. The substrate has a thickness measured from the top surface to the bottom surface of between 10 nm and 1 mm. In an embodiment, the substrate has a thickness of 500 μm. In an embodiment, the substrate is made of a fused silica material.

The reflector includes a top coating applied to the top surface of the substrate. The top coating is an absorber layer having high conductivity and includes a conductive element disposed thereon. The conductive element includes a conductive region that is surrounded by an absence region that is configured to enable the propagation of THz bands therethrough. In an embodiment, the absorber layer has a thickness of 100 nm. In an embodiment, the conductive elements of the absorber layer is made of a titanium/gold metamaterial.

The reflector also includes a bottom coating applied to the bottom surface of the substrate. The bottom coating is a backplane layer having high conductivity. In an embodiment, the backplane layer has a thickness of 100 nm. In an embodiment, the backplane layer is made of a titanium/gold metamaterial.

An embodiment of the absorber layer includes a conductive region that is shaped as a cross having two perpendicularly intersecting sections that are equal in area and that each intersect at a midpoint of an opposing intersecting section. In an embodiment, a width of each of the two perpendicularly intersecting sections is between 2 μm and 4.5 μm. In an embodiment, a width of the defined absence region surrounding the conductive element is between 2.5 μm and 4 μm.

An embodiment of the absorber layer includes a plurality of conductive elements disposed thereon. In an embodiment, each conductive region is shaped as a cross having two perpendicularly intersecting sections that are equal in area and that each intersect at a midpoint of an opposing intersecting section. In an embodiment, the plurality of conductive elements are arranged in a consistent pattern, such that each of the plurality of conductive elements is spaced apart from adjacent conductive elements by an equal distance that defines a periodicity of the plurality of conductive elements. In an embodiment, the periodicity of the plurality of conductive elements is between 25 μm and 45 μm. In an embodiment, the consistent pattern of the plurality of conductive elements includes a cumulative area of 360 mm2.

An embodiment of the reflector includes a plurality of layers each including a substrate, a top coating, and a bottom coating forming the reflector. In an embodiment, a top layer of the plurality of layers includes an absence region of the top coating having a first area, and a bottom layer of the plurality of layers includes an absence region of the top coating having a second area, with the first area being greater than the second area, thereby enhancing a tuning capacity for attenuation of the THz bands therethrough.

An object of the invention is to provide a THz band stop reflector that includes absorption bands that are independent of an incidence angle and polarization, such as for use in the detection of illicit organic substances by law enforcement, astronomy and military imaging, container screening, radar cloaking, phototherapy applications, and telecommunications, among other applications.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a graph illustrating Fused silica optical propagation properties in the THz to Mid-IR range [16].

FIG. 2 is an elevation view of an embodiment of the layers of the filter, according to embodiments of the present disclosure.

FIG. 3 is top plan view of an embodiment of the metamaterial design used within the filter of FIG. 2, according to embodiments of the present disclosure.

FIG. 4 is a micrograph of an embodiment of the filter of FIG. 2 including the metamaterial design shown in FIG. 3, according to embodiments of the present disclosure.

FIG. 5 is an exploded view of an embodiment of a substrate of the filter of FIG. 2 showing a plurality of layers, according to embodiments of the present disclosure.

FIG. 6 graphically depicts the far-infrared complex permittivity spectrum for gold (shown in section A) and of the spectra for infrared index n and extinction coefficient K for fused silica (shown in section B), according to embodiments of the present disclosure.

FIG. 7 depicts an embodiment of a beam path diagram of a reflectivity rig used for testing the filter of FIG. 2, according to embodiments of the present disclosure.

FIG. 8 graphically depicts unpolarized normal incidence reflectance spectra for measured results (shown in section A) simulation results (shown in section B) for tested filter patterns in five samples, according to embodiments of the present disclosure.

FIG. 9 graphically depicts polarization dependence results for the filter pattern of Sample 1, showing simulated results in section A and measured results in section B, according to embodiments of the present disclosure.

FIG. 10 graphically depicts the effects of various incidence angles on the reflectance of Sample 1, showing measured results (shown in section A), simulated transverse magnetic (TM) results (shown in section B), and simulated transverse electric (TE) results (shown in section C), according to embodiments of the present disclosure.

FIG. 11 depicts an embodiment of a beam path between two band stop filters, showing the incident flux as a function of frequency for each beam, according to embodiments of the present disclosure.

FIG. 12 graphically depicts the electrical characteristics of embodiments of the present invention, showing maximum resonance on a surface of embodiments of the filter patterns, according to embodiments of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

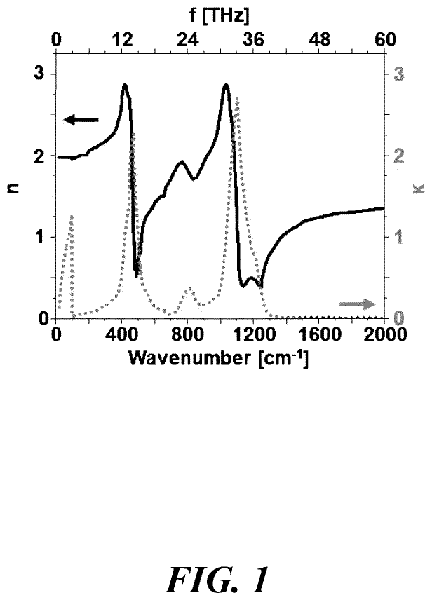

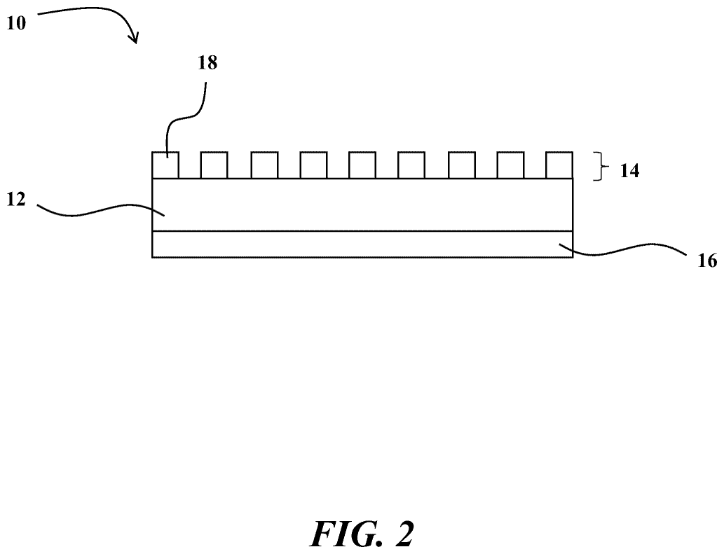

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

s used herein, the term “Absence Region” generally refers to the area surrounding a conductive region within the absorber layer of the top coating. This region may lack conductive material and/or may be formed to enable the propagation of specific frequencies of electromagnetic radiation through the surrounding structure. The absence region may be integral to the design of the metamaterial pattern and contributes to the impedance-matching characteristics of the reflector. Its size and/or configuration can be varied between layers of the multilayer reflector, particularly with a larger area in the top layer and/or a smaller area in the bottom layer, contributing to tunable spectral attenuation. The dimensions of the absence region may be defined by a width in micrometers and influence the spectral response characteristics of the band stop reflector.

As used herein, the term “Absorber Layer” generally refers to the high conductivity top coating applied to the upper surface of the substrate within each layer of the band stop reflector. The absorber layer may comprise conductive elements arranged in a defined pattern, typically with conductive regions surrounded by absence regions. This layer may be responsible for the absorption and reflection of targeted electromagnetic radiation. The absorber layer may consist of titanium/gold metamaterial and typically has a nanoscale thickness (e.g., 100 nm), although other conductive materials and/or thicknesses may be used to achieve specific performance characteristics. The geometry and/or periodicity of the absorber layer play a central role in defining the resonance behavior of the device.

As used herein, the term “Backplane Layer” generally refers to the high conductivity bottom coating applied to the lower surface of the substrate in each layer of the reflector. This layer may serve as an electrically and thermally conductive base that reflects electromagnetic radiation not attenuated by the absorber layer. The backplane layer may be formed from a titanium/gold metamaterial and may have a thickness on the order of 100 nm. The presence of the backplane layer can support the formation of a resonant cavity between it and the patterned absorber layer, contributing to the frequency selectivity of the structure. It may also function to reduce the transmission of energy through the reflector and redirect energy back toward the absorber layer.

As used herein, the term “Band Stop Reflector” generally refers to a multilayer device designed to inhibit or attenuate specific spectral components of electromagnetic radiation. Each layer in the reflector can include a substrate, a top coating functioning as an absorber layer, and/or a bottom coating functioning as a backplane layer. The reflector may be configured to form resonant cavities that selectively block specific frequencies while allowing others to propagate. The stacking of multiple such layers, each with differently dimensioned absence regions in the absorber layers, may enable tunable filtering characteristics. The reflector may be applied in systems requiring selective suppression of narrowband electromagnetic signals.

As used herein, the term “Bottom Coating” generally refers to the conductive layer applied to the bottom surface of the substrate in each layer of the reflector. This layer can be synonymous with the backplane layer and is made from a conductive material to reflect incident radiation and/or establish boundary conditions for spectral filtering. The bottom coating may have a thickness in the range of nanometers and/or may be deposited using processes such as electron beam evaporation. The interaction of this layer with the absorber layer may define the resonance and/or absorption profile of each individual filter layer.

As used herein, the term “Conductive Element” generally refers to the metallic feature or structure formed on the absorber layer of the top coating. Each conductive element may include a conductive region and is arranged in a geometric pattern surrounded by an absence region. The conductive elements may be typically patterned using lithography techniques and may take the shape of a cross with perpendicular arms intersecting at a midpoint. The arrangement and/or dimensions of the conductive elements can determine the spectral properties of the absorber layer by inducing plasmonic resonances when interacting with incident radiation.

As used herein, the term “Conductive Region” generally refers to the portion of a conductive element that contains deposited conductive material, typically metallic. The conductive region can form the primary feature of the absorber layer and/or may be shaped as a cross with equal-area intersecting segments. This region may interact directly with the electric field of incident radiation and/or can play a central role in establishing the frequency-dependent response of the band stop reflector. The conductive region may be surrounded by an absence region and/or may be arranged in a periodic pattern across the substrate surface.

As used herein, the term “Consistent Pattern” generally refers to the spatial arrangement of multiple conductive elements on the absorber layer, where each element is placed at regular intervals. This pattern may be defined by a uniform spacing between adjacent conductive regions, which sets the periodicity of the metamaterial layer. The consistent pattern ensures predictable spectral filtering behavior across the entire active surface of the reflector. The geometric parameters of the consistent pattern, including periodicity, feature width, and/or spacing, contribute to the uniformity of the resonance response.

As used herein, the term “Cross” generally refers to the geometric shape of the conductive region within the absorber layer, having two perpendicularly intersecting sections that are equal in area. The intersection of these sections occurs at their midpoints, creating a symmetric structure that supports polarization-independent resonances. The cross shape may be formed by patterning a metal layer using photolithography and contributes to the spectral selectivity of the absorber layer when combined with an adjacent backplane layer.

As used herein, the term “Electromagnetic Radiation” generally refers to the energy propagated through space in the form of oscillating electric and magnetic fields. In the context of the present disclosure, this term can apply to a broad range of frequencies including, but not limited to, those in the terahertz regime. The band stop reflector may be designed to attenuate selected frequencies of electromagnetic radiation using geometrically and/or materially tuned resonant structures within the absorber and backplane layers of the multilayer device.

As used herein, the term “First Area” generally refers to the size of the absence region surrounding the conductive region in the top coating of the top layer of the reflector. This area may be designed to be larger than the corresponding absence region in the bottom layer to establish a spatial gradient in the reflector stack. The relative sizes of these areas influence the depth and/or bandwidth of spectral attenuation and provide a means to tune the reflector's frequency response by varying pattern geometry layer by layer.

As used herein, the term “High Conductivity” generally refers to the electrical property of the materials used for both the absorber and backplane layers in the band stop reflector. These layers may consist of metals or metal alloys such as titanium/gold, and are selected to provide low resistivity for supporting surface currents and enabling resonance interactions with incident radiation. High conductivity can be essential for achieving the desired reflectance and/or absorption characteristics in the spectral band of interest.

As used herein, the term “Layer” generally refers to a single unit in the multilayer construction of the band stop reflector. Each layer may include a substrate with a top coating and a bottom coating. The top coating can form the absorber layer containing patterned conductive elements, while the bottom coating may form the backplane layer. Multiple such layers can be assembled in a stack, with design parameters such as absence region size varying between layers to tailor the spectral response of the complete device.

As used herein, the term “Patterned Conductive Region” generally refers to a geometric configuration of conductive material on the absorber layer, which may be shaped into cross forms or other repeatable structures. These regions can be created through fabrication methods such as contact photolithography and define the electromagnetic response of the band stop reflector through their dimensions, shapes, and arrangement. The patterning may enable surface plasmon resonance effects and determines the spectral location of absorption peaks.

As used herein, the term “Periodicity” generally refers to the center-to-center spacing between adjacent conductive elements within the absorber layer's consistent pattern. This parameter may govern the coupling between elements and can determine the resonance frequency of the metamaterial structure. The periodicity may be defined within a specific range in micrometers and can be tuned to shift the response of the band stop reflector to desired wavelengths.

As used herein, the term “Plurality of Layers” generally refers to two or more individual filter structures, each including a substrate, a top coating, and a bottom coating, that can be arranged in sequence to form a stacked assembly. Each layer may operate in conjunction with the others to produce a composite filtering effect, with varying absence region sizes between layers enabling enhanced spectral tuning. The multilayer configuration may also enable sharper attenuation profiles and/or greater control over spectral selectivity.

As used herein, the term “Second Area” generally refers to the size of the absence region in the absorber layer of the bottom layer of the multilayer reflector. This area can be smaller than the first area found in the top layer and/or may be part of a gradient configuration that allows the spectral response to be tuned across the stack. By varying the second area relative to the first, the design may support selective attenuation of specific frequencies through cumulative resonant effects.

As used herein, the term “Spectral Attenuation” generally refers to the reduction in intensity of electromagnetic radiation at specific wavelengths or frequency bands as a result of interaction with the band stop reflector. This attenuation can be achieved through the design of the absorber layer and backplane layer, as well as the configuration of conductive regions and absence regions across the multilayer stack. The degree of attenuation may be influenced by parameters such as material composition, geometry, and thickness.

As used herein, the term “Substrate” generally refers to the structural layer in each filter unit that supports the top and bottom coatings. The substrate may be made of fused silica or another material with minimal absorption features in the desired spectral range. It can provide mechanical support and/or a dielectric medium between the absorber and backplane layers. The thickness and/or optical properties of the substrate can influence the effective resonance behavior of the filter.

As used herein, the term “Top Coating” generally refers to the absorber layer deposited on the top surface of the substrate in each layer of the band stop reflector. This coating may include the patterned conductive elements and absence regions that define the resonance characteristics of the layer. The top coating may be fabricated using thin-film deposition followed by photolithographic patterning, and/or its design can be essential to achieving the desired spectral filtering behavior of the reflector.

As used herein, the terms “About,” “Approximately,” or “Roughly” generally refer to being within an acceptable error range (i.e., tolerance) for the particular value as determined by one of ordinary skill in the art, which will depend in part on how the value is measured or determined (e.g., the limitations of a measurement system) (e.g., the degree of precision required for a particular purpose, such as optimizing an ultra-spectrally selective terahertz (THz) band stop reflector). As used herein, “About,” “Approximately,” or “Roughly” refer to within ±25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Band Stop Reflector:

The present invention includes an ultra-spectrally selective THz band stop reflector. Metamaterials, or engineered surfaces, often utilize plasmonic resonances to enable spectrally selective absorbers. The present invention uses these devices for narrow-band spectral filters by applying a metamaterial to a substrate with limited absorption features at predetermined wavelengths.

In embodiments, the present invention is able to inhibit the reflectance of electromagnetic radiation in the THz frequency range. This characterization is a combination of material and geometric parameters which are unique and tunable enabling resonating frequencies (spectral selectivity) in the THz range with narrow channel widths (full width at half maximum values, or FWHM) controllable by the thickness and electrical properties of the crystalline material. In these embodiments, this device may be integrated with broadband sources or co-integrated with other analytical detection methods (e.g., chromatography, Fourier Transform Reflectance Spectroscopy).

In embodiments, the narrow-band spectral filter may comprise a unique geometry that utilizes a thin wafer substrate (approximately 10 nm<h<1 mm) of crystalline (mono, or poly) material, or flexible polymer film, which may or may not have sharp characteristic features in its permittivity over the frequency ranges of interest. A high conductivity coating is then applied to the top and bottom surfaces. In these embodiments, these coatings provide two primary features: (1) the conductive nature of the coating enables electrical charge distribution; and (2) the geometric openings which are regularly spaced patterns enable impedance matching with an electromagnetic wave propagating in a dissimilar medium.

As shown in FIG. 2, embodiments of the narrow-band spectral filter 10 may include a fused silica substrate 12 sandwiched between an absorber layer 14 (the top coating) and a backplane layer 16 (the bottom coating). Fused silica was initially selected as the substrate 12 because it has no absorption features of its own below 450 cm⁻¹ (13.5 THz) and no inherent refractive index variations in the sub 5 THz range (See FIG. 1) [16]. Thus, validation of the filter 10 could be readily determined during testing. However, it should be understood that alternative substrates with different absorption properties may be used depending on the desired boundaries of the spectral filter. In addition, the tested substrate 12 has a thickness of 500 μm; however, this thickness can be adjusted to modify the properties of the filter 10.

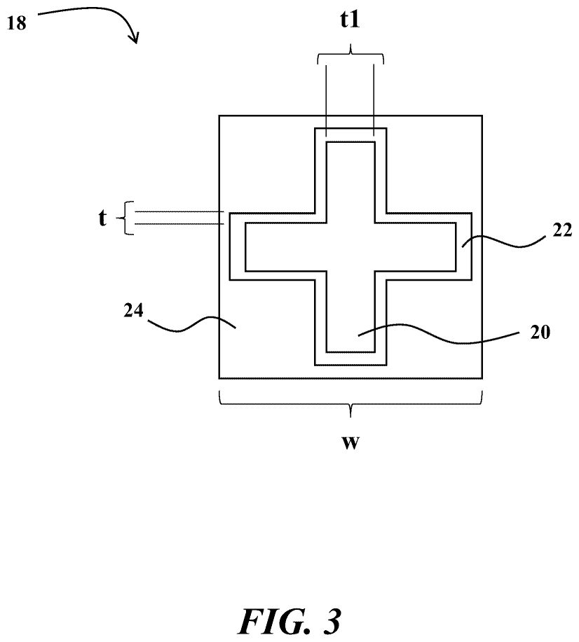

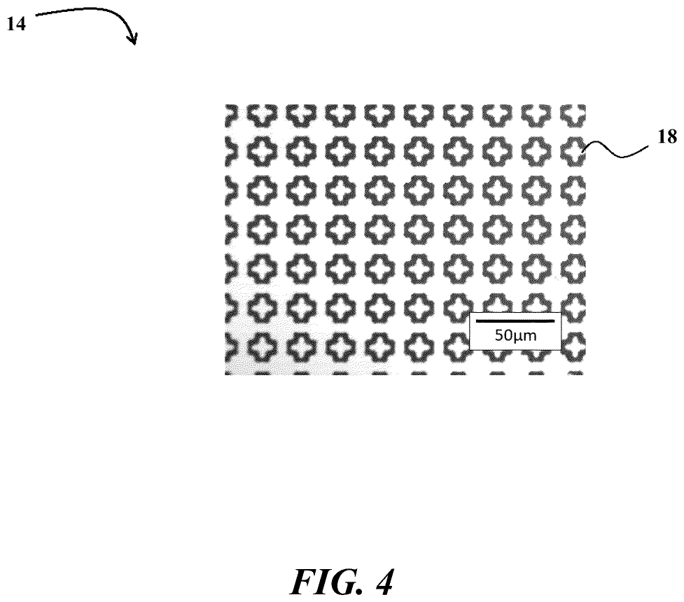

In embodiments, the absorber layer 14 includes of a plurality of equidistantly spaced conductive elements 18 comprised of metamaterial. The conductive elements 18, and particularly the conductive components 20 of the conductive elements 18, have a distinct pattern as depicted in FIGS. 3-4. In some embodiments, the distinct pattern is generally shaped like a cross or +shape; a pattern including superimposed crosses atop each other to form a #shape may also be considered. Referring to FIG. 3, in embodiments, the conductive component 20 of the conductive element 18 is surrounded by an absence region 22, with the conductive component 20 and the absence region 22 being disposed on a large continuous area 24. The planar width of the arms of the cross of the conductive component 20 are represented by t1, which can be a predetermined value between approximately 2 and 4.5 μm. The absence region 22 defines a distance, represented by t, between the conductive component 20 and the continuous area 24. That distance t can be a predetermined value between approximately 2.5 and 4 μm. Finally, the pattern has a periodicity represented by W. In some embodiments, the periodicity is between approximately 25 and 45 μm. As the periodicity of the metamaterial increases, the absorption frequency redshifts (i.e., decreases, with a corresponding increase in wavelength), as is expected from plasmonic structures.

In embodiments, the pattern of the conductive elements 18 may include a periodically repeating arrangement of symmetrical square-shaped conductive elements to fill ˜360 mm² of the thin wafer substrate (an embodiment of which is shown in FIG. 4). The patterning is achieved by contact photolithography onto a dual sided polished (DSP) 500 μm thick (Z dimension) fused silica wafer, which will described in greater detail in the sections below.

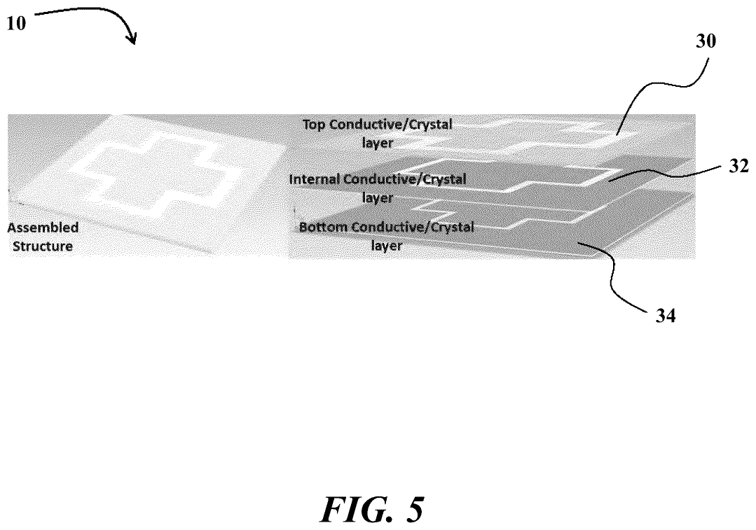

Some embodiments of the narrow-band spectral filter 10, as exemplified in FIG. 5, include several filter layers. The depicted embodiment includes a top layer 30, an internal layer 32, and a bottom layer 34. Each filter layer includes a metamaterial (absorber layer 14) disposed on a substrate 12, as described above. As shown, in some embodiments, the absence region 22 for each absorber layer 14 becomes smaller moving from the top layer 30 to the internal layer 32, and from the internal layer 32 to the bottom layer 34. The progressively smaller absence regions 22 from the top layer 30 toward the bottom layer 34 enables the propagation of waves into the band stop layers to enable a larger tuning capacity for attenuation. The number of layers, the size of the absence region 22, and size of the conductive elements 18 impact the properties of the filter 10 and can therefore be tailored to achieve certain results, such as acting as very sharp filters.

In embodiments, the thickness of the metamaterial may be about 100 nm; however, some embodiments may have different thicknesses depending on the intended properties of the filter 10. Some embodiments of the metamaterial have a thickness in a range of 1 nm to 3 mm. In addition, the tested metamaterial was Titanium/gold (Ti/Au); however, some embodiments of the metamaterial are comprised of different material depending on the intended properties of the filter 10. In various embodiments, the metamaterial may be metal, metalloids, structured dielectrics. However, the use of a structured dielectric, such as N or P doped silicon, impose unique characteristics to the filter 10 based on the intensity of the incident radiation.

Moreover, in embodiments, the backplane may be an electrically and thermally conductive material designed to reflect electromagnetic (EM) waves of predetermined wavelengths. The tested backplane was comprised of 100 nm thick Ti/Au. However, some embodiments of the backplane have different thicknesses depending on the intended properties of the filter 10. In addition, some embodiments of the metamaterial are comprised of different electrically conductive materials, including but not limited to Au, Cr, Ti, Ni, Cu, Co, Fe, Si, V, Rh, Ru, Mg, Ge, graphene, and ceramics thereof, depending on the intended properties of the filter 10.

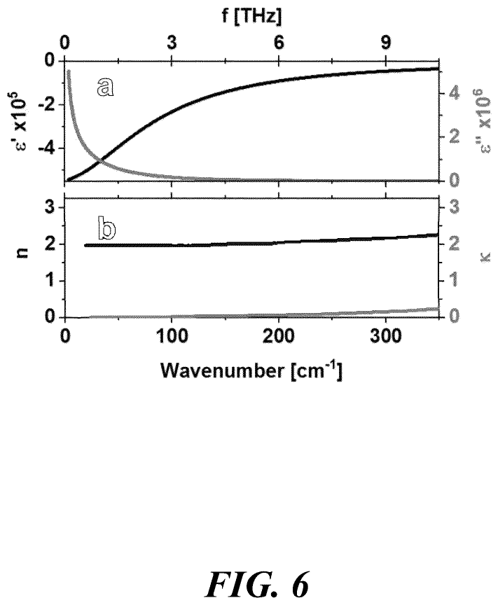

As shown in FIG. 6, in embodiments, the spectra for the infrared index n and/or extinction coefficient k for fused silica may show that there is a negligible variation of the infrared index below 6 THz. In particular, an extinction peak found at 2.8 THz gives no significant dispersion feature to the index spectrum. Dispersion features have been shown to give rise to unintended resonances [27]. Thus, any resonances below 6 THz are determined by the design geometry of the narrow-band spectral filter. In addition, FIG. 6 shows the far-infrared complex permittivity spectrum for gold with real and imaginary parts ε′ and ε″, respectively. As shown, no sharp features that might lead to parasitic resonances are present in the spectrum.

In some embodiments, the Q factor and wavelength center of the filter can be modified by biasing the electrical contacts at a specified potential enabling dynamic control of reflectivity.

In some embodiments, one or more of the present inventions can be integrated into a waveguide as part of an etalon.

### Experimental Testing

Narrow-band far infrared (FIR) filters 10 were simulated via finite element analysis and subsequently manufactured using contact photolithography and e-beam metal deposition processes. Alternative methods of fabrication can also include but are not limited to screen printing, slip/tape casting, and laser etching. Manufactured filter performance was then quantitatively measured using Fourier transform infrared (FTIR) spectrometry. The filter 10 configuration consists of a fused silica wafer (SiOₓ-500 μm) substrate 12 with an electrically and thermally conductive backplane layer 16 (Ti/Au 100 nm) with a metamaterial absorber layer 14 (Ti/Au 100 nm) on the incident surface of the substrate 12. Attenuation of reflected signals was observed on the order of (−4.0)-(−7.2) dB seen between 50 and 200 cm⁻¹ (1.5 and 6 THz) with FWHM values of 20-56 cm⁻¹ (0.6-1.68 THz). Furthermore, a close agreement between simulation and measurements was observed.

The geometry of the metamaterial designs utilized in the tested filter 10 were fabricated using a previously published configuration first discussed in Arose et al. [3, 17]. The devices were patterned by contact photolithography onto dual sided polished (DSP) 500 μm thick fused silica wafer substrates 12 (FIG. 2). A backplane with thickness 100 nm was applied as a Ti sticking layer and Au overlayer to form the backplane layer 16. The metamaterial patterned layer thickness was also 100 nm and consisted of the same material for the absorber layer 14. All metal layers were deposited by e-beam evaporation. On each sample, a patterned area of 360 mm², was achieved and held constant during all subsequent experiments. This area corresponds to a minimum of 423 units in the metamaterial pattern, as pattern size shrinks with higher frequency the number of units increases.

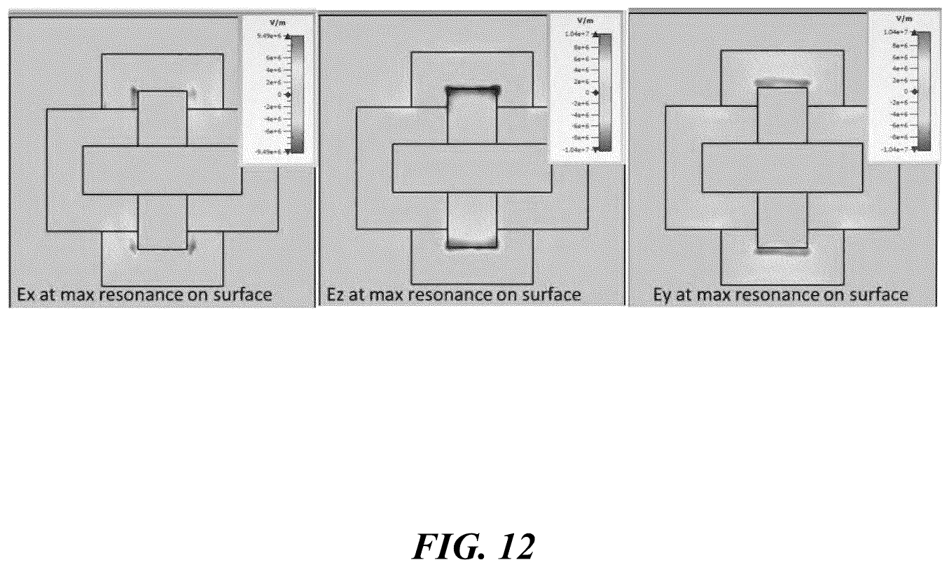

The definition of geometry and subsequent simulations of the reflector were conducted in a high frequency 3D simulation package utilizing finite element analysis (FEA) marketed under the trade name CST Studio Suite® 2019 (3DS Dassault Systems, Vélizy-Villacoublay, France). Au was simulated with a Drude fit model, and silica was simulated with a Lorentzian fit with property data obtained from Derkachova and Kitamura, respectively [15, 26]. Periodic boundary conditions were used in simulation with a minimum standoff distance of 25 μm between the object of interest and the Fairfield incident boundary Exy. At perpendicular planes, Eyz and Exz, a symmetric boundary was implemented (see FIG. 12).

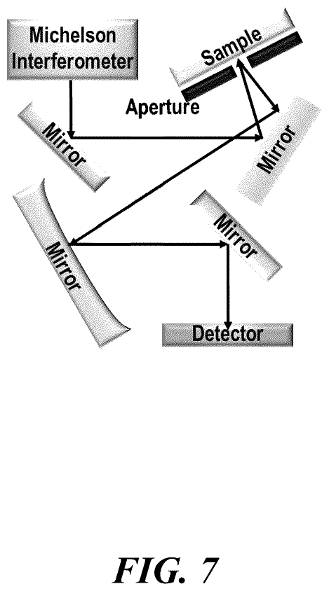

Reflectance spectra were obtained using a Michaelson Interformeter, (Bomem DA8) FTIR spectrometer (ABB Ltd, Zürich, Switzerland) at a resolution of 8 cm⁻¹ between data points. An aperture of 31.4 mm² was used within the optical system to ensure uniform illumination of sufficient pattern periods while avoiding the edges of the substrate. A 3x-beam condenser and spectral reflectance accessory (e.g., Perkin-Elmer) was used for measurements, with the beam being oriented toward the sample in a converging manner at near-normal incidence (e.g., approximately 8° deviation from normal). A diagram of an embodiment of the beam path can be seen in FIGS. 7, and 400-500 scan averages were taken for each sample to minimize the effect of noise from thermal sources. The variable angle reflectance accessory (e.g., Agilant Technologies) permitted incidence angles from 20° to 60°. A gold mirror was used for the reflectance reference. Reflectance was calculated as the ratio of sample to reference reflected power. A wire-grid on polyethylene far-IR polarizer was used for polarization studies.

Before each measurement, the maximum observed pressure within the FITR was 500±20 mTorr. Any air within the device would have been sourced from laboratory at 20±3° C. and indoor air relative humidity. Thus, a maximum water vapor concentration would be 1.06 μmol/m³.

A nearest-neighbor averaging technique was implemented to mitigate the prominence of Fabry-Perot resonances; such averaging better indicated the presence of the sampling information available from the instrumentation.

### Results

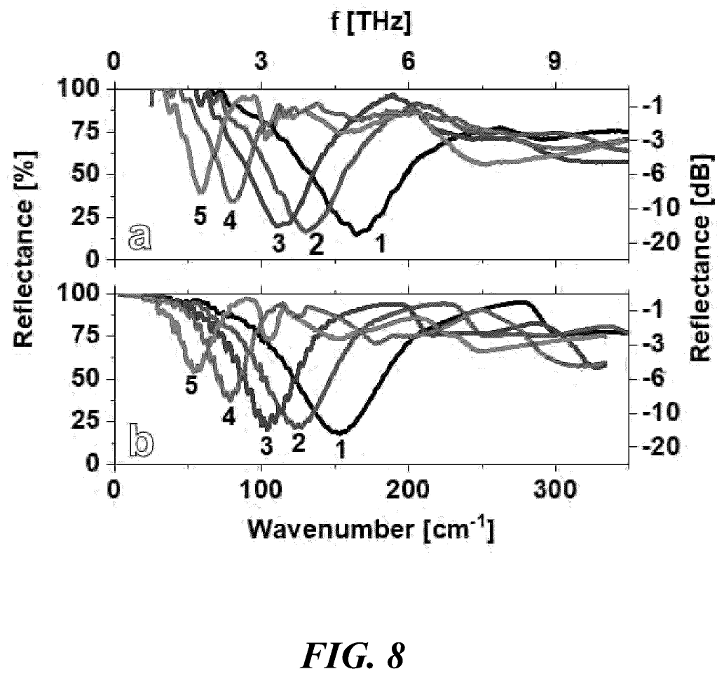

FIG. 8 graphically depicts the unpolarized simulated and measured reflectance spectra (R) at near-normal incidence for five tested samples, with geometrical parameter values provided in TABLE 1 below. Each sample is consistently defined as a given line color. As can be seen in FIG. 8 between the top plot shown in section A (i.e., measured results) and bottom plot shown in section B (i.e., simulated results), there is a good agreement between simulated and measured results, with the maximum difference in position of the minimum reflectance of a simulated and measured result being 8% (See Sample 4). Furthermore, amplitude differences are on the order of 1 dB. From FIG. 1, no spurious resonances are expected for silica in this spectral range, so the observed features can be attributed to the pattern of the metamaterial layer and the coupling between the backplane and metamaterial. A measured minimum reflectance of 19% can be seen for sample 1, and a minimum reflectance of 40% is seen for Sample 5, with all other samples' reflectance falling between these two values. This corresponds to an attenuation of −17 dB for sample 1, and −8.5 dB for Sample 5. The Q factor for each sample can be seen in Table 1. All Q=f/Δf values are above ½, which indicates that these resonators are underdamped, as desired for high selectivity. These observed attenuations can be tuned by controlling the material thickness. A thinner layer of silica will lead to less scattering loss in the material, and thus deepen the absorption features [3].

TABLE 1

| Sample | W (μm) | t (μm) | t1 (μm) |
|---|---|---|---|
| 1 | 25 | 3 | 4 |
| 2 | 30 | 3.5 | 4 |
| 3 | 35 | 4 | 4.5 |
| 4 | 40 | 3 | 2 |
| 5 | 45 | 2.5 | 4 |

| | | | | | Reflectance | |
|---|---|---|---|---|---|---|
| | Q-factor | | Centerline (THz) | | Minimum (dB) | |
| Sample | Measured | Simulated | Measured | Simulated | Measured | Simulated |
| 1 | 2.8 | 2.2 | 5.0 | 4.6 | −17 | −15 |
| 2 | 2.4 | 2.2 | 3.9 | 3.8 | −16 | −13 |
| 3 | 2.2 | 2.3 | 3.4 | 3.1 | −14 | −13 |
| 4 | 3.2 | 2.9 | 2.5 | 2.4 | −10 | −8.0 |
| 5 | 2.9 | 1.9 | 1.7 | 1.7 | −8.5 | −5.4 |

As the periodicity of the metamaterial (W parameter) increases, the absorption frequency redshifts, as graphically depicted in FIG. 8. Such behavior is expected from plasmonic structures [28]. Periodic ripples in the simulated spectra, which can most clearly be seen in the reflectance plot for Sample 3 (See FIG. 8), are spaced evenly at ˜4.5 cm-1. Such behavior is Fabry-Perot resonances, as the dissimilar refractive index of the substrate forms an optical cavity. Spacings between successive peaks are presented in Equation 1, where n is the refractive index (˜2), d is the thickness of the cavity (500 μm), and Δv is the separation of the features in wavenumbers; which attributes a nominal 5 cm⁻¹ spacing for said resonances. As the scanning resolution of the FTIR spectrometer was set at 8 cm⁻¹, these features are poorly resolved and thus are predominantly absent from the measured data.

$$Δν = \frac{1}{2 n d} \qquad ( Equation 1 )$$

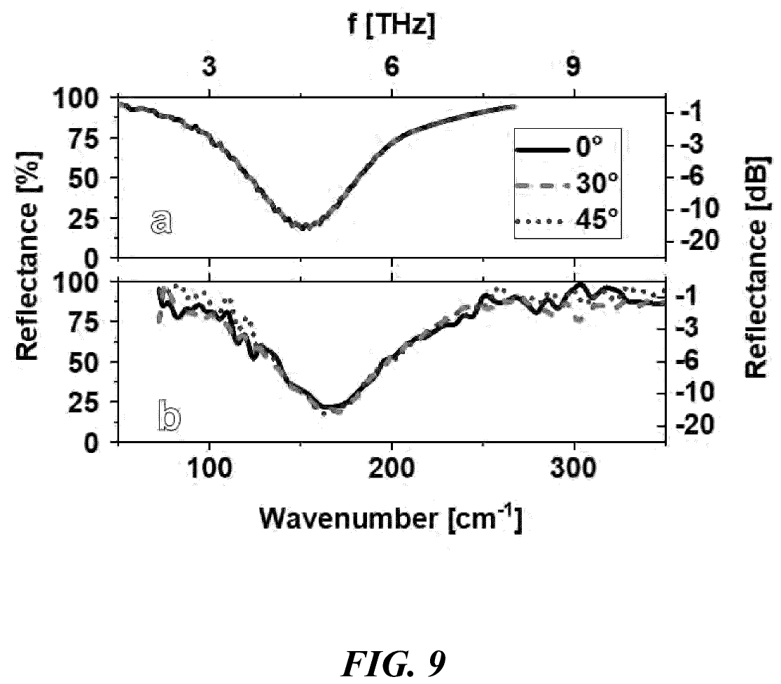

FIG. 9 graphically depicts polarization dependence for normal incidence on Sample 1 (in section A of FIG. 9) and the measured reflectance spectra for Sample 1 (in section B of FIG. 9). As shown in FIG. 9, the peak values are polarization independent, which is verified by the simulated reflectance spectrum shown in section A, where all curves coincide. In addition, as shown in section B of FIG. 9, any polarization effects are less than the ˜5% experimental uncertainty for the measured reflectance spectra.

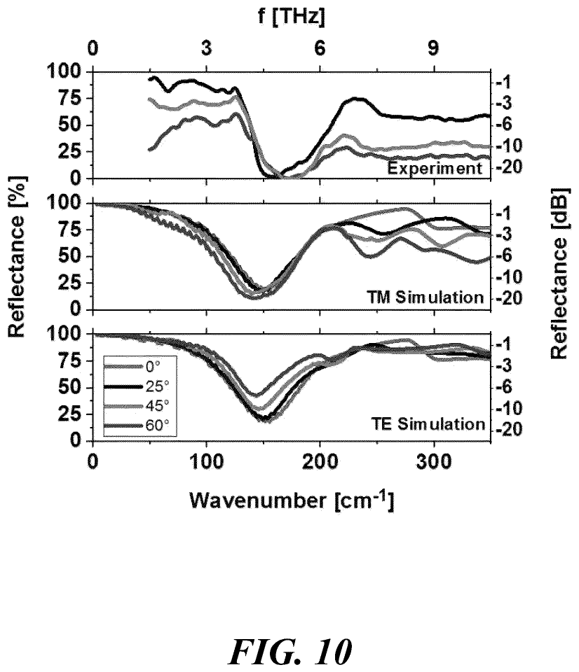

In addition, FIG. 10 shows the effects of the angle of incidence on Sample 1, showing the measured experimental data in section A, the transverse magnetic (TM) results in section B, and simulated transverse electric (TE) results in section C. As shown in FIG. 10, there are differences in behavior with increasing angles of incidence. In particular, absorption decreases for TE polarization angle increases, and both modes exhibited a small redshift. The uncertainties in the unpolarized experiment with the variable angle accessory were too large to observe these changes.

Measurements were taken at higher wavenumbers to determine if any further resonances besides those attributable to the pattern existed. A resonance was seen at 450 cm⁻¹ (13.5 THz) and another feature was seen at 1100 cm⁻¹ (33.0 THz). These line up with expected absorption features for silica [16], but with slight shifts between samples. These shifts have been explored previously by Evans et. al and further explanation can be seen therewithin [27].

The use of a metamaterial absorber layer 14 as part of a band attenuating reflecting THz filter was investigated. Measured samples produced showcased the largest FWHM observed was 56 cm⁻¹ (1.68 THz) with ˜86% absorption at 5 THz center frequency, while the smallest FWHM observed was 20 cm⁻¹ (0.6 THz) with an absorption of ˜61% at 1.7 THz. The absorption bands were independent on incidence angles up to 60° and were independent of polarization. Such absorbers are useful as band-blocking filters on curved surfaces such as focusing mirrors used in spectroscopy or laser applications.

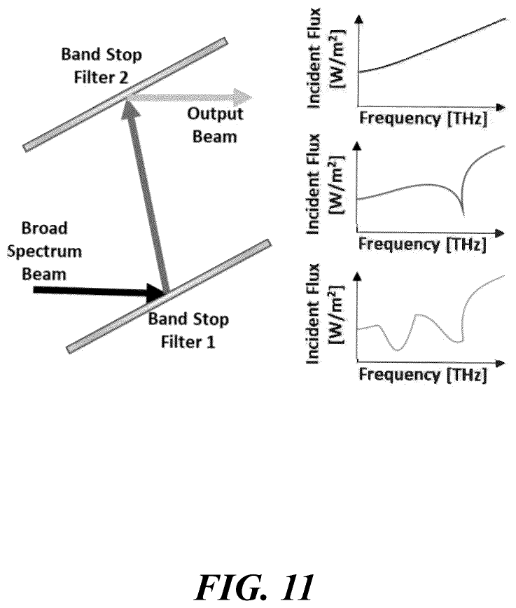

Numerous successive applications of this device may also be used such that there is the formation of a bandpass regions between two band stop regions, as exemplified in FIG. 11. The input beam with blackbody intensity is filtered by the band stop filter, the reflected beam (shown in blue) then has a missing photon packet. Upon a subsequent reflection, there is a second energy dissipation leaving the output beam (shown in green) to have a highly concentrated narrow band pass region. In a similar manner, two closely spaced band stop regions may be incorporated such that highly controlled portions of the spectrum are attenuated.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

[1] Jun Wang, J. G., and Weizhi Li, Preparation of room temperature terahertz detector with lithium tantalate crystal and thin film. AIP Advances, 2014. 4.
[2] W. D. Zhang, A. B., L. S. Himed, E. R. Brown, Spectroscopic Sensing of Opioids in the THz Region, in IEEE National Aerospace and Electronics Conference. 2019, IEEE: Dayton, OH.
[3] G. Ducournau, Silicon photonics targets terahertz region. Nature Photonics, 2018. 12 (10): p. 574-575.
[4] K. R. Armstrong, F. J. L., Far-infrared filters utilizing small particle scattering and antireflection coatings. Applied Optics, 1974. 13 (2).
[5] K. J. Leiptoldt, T. H., E. Kreysa, H. P. Gemund, Scattering matrix methods for far-infrared metal mesh filters. International Journal of Infrared and Millimeter Waves 1991. 12 (3).
[6] R. Szipocs, A. K.-K., P. Apai, E. Finger, A. Euteneuer, M. Hofmann, Spectral filtering of femtosecond laser pulses by interference filters. Appl. Phys. Lett. B, 2000. 70.
[8] J. Cunningham, C. W., A. G. Davies, I. Hunter, E. H. Linfield, H. E. Beere, Terahertz frequency range band-stop filters. Appl. Phys. Lett., 2005. 86.
[9] D. Zhai, R. Z., Z. Geng, B. Cui, Y. Yang, A High-Selectivity THz Band-Stop Filter Based on a Flexible Polymide Film. SPIE, 2018. 10826.
[10] R. L. Fante and M. T. McCormack, Reflection Properties of the Salisbury Screen. IEEE Transactions on Antennas and Propagation, 1988. 36 (10).
[11] A. N. Reddy, S. Raghavan, Split ring resonator and its evolved structures over the past decade. IEEE International Conference On Emerging Trends in Computing, Communication, and Nanotechnology, 2013.
[12] John H. Goldsmith, S. Vangala, Joshua R. Hendrickson, Justin W. Cleary, and Jarrett H. Vella, Long-wave infrared selective pyroelectric detector using plasmonic near-perfect absorbers and highly oriented aluminum nitride. J. Opt. Soc. Am., 2017. B 34: p. 1965-1970.
[13] J. Nath, S. Modak, I. Rezadad, D. Panjwani, F. Rezaie, J. W. Cleary, and R. E. Peale, Far-infrared absorber based on standing-waveresonances in metal-dielectric-metal cavity. Optics Express, 2015. 23 (16).
[14] J. Le Perchec, R. E. Lamaestre, M. Brun, N. Rochat, O. Gravrand, G. Badano, J. Hazart, and S. Nicoletti, High rejection bandpass optical filters based on sub-wavelength metal patcharrays. Optics Express, 2011. 19 (17).
[15] A. Derkachova, K. S., I. Demchenko, Dielectric Function for Gold in Plasmonics Applications: Size Dependence of Plasmon Resonance Frequencies and Damping Rates for Nanospheres. Plasmonics, 2015. 11.
[16] A. Datta, Z. Z., X. Xu, Split ring resonator as a nanoscale optical transducre for heat-assisted magnetic recording. Optics Express, 2019. 27.
[17] Talghader, J., Gawarikar, A. & Shea, R, Spectral selectivity in infrared thermal detection. Light Sci Appl, 2012. 1.
[18] Ebbesen, T., Lezec, H., Ghaemi, H. et al, Extraordinary optical transmission through sub-wavelength hole arrays. Nature, 1998. 391: p. 6677-669.
[19] B. Wang, L. W., G. Wang, W. Huang, X. Li and X. Zhai, Theoretical Investigation of Broadband and Wide-Angle Terahertz Metamaterial Absorber. IEEE Photonics Technology Letters, 2014. 26: p. 111-114.
[20] Thang Duy Dao, S. I., Takahiro Yokoyama, Tomomi Sawada, Ramu Pasupathi Sugavaneshwar, Kai Chen, Yoshiki Wada, Toshihide Nabatame, and Tadaaki Nagao, Hole Array Perfect Absorbers for Spectrally Selective Midwavelength Infrared Pyroelectric Detectors. ACS Publications, 2016. 3: p. 1271-1278.
[21] H. Tao, C.M.B., D. Pilon, K. Fan, A. C. Strikwerda, D. Shrekenhamer, W. J. Padilla, X. Zhang, R. D. Averitt, A dual band terahertz metamaterial absorber. J. Phys. D: Appl. Phys, 2010. 43.
[22] S. Ghosh and K. V. Srivastava, Polarization-insensitive single-and broadband switchable absorber/reflector and its realization using a novel biasing technique. IEEE Transactions on Antennas and Propagation, 2016. 64 (8): p. 3665-3670.
[23] C. Arose, A.C.T., R.E. Peale, F. J. Gonzalez, Z. Loparo, J. Cetnar, S. S. Vasu, Far-infrared spectrally selective LiTaO3 and AlN pyroelectric detectors using resonant subwavelength metal surface structures. MRS Advances, 2020. 5 (31-32).
[24] A. C. Terracciano, C. A., S. S. Vasu, Ultra-Spectrally Selective THz Band Stop Reflector. 2021: United States of America.
[25] A. Staykov, et al., The stability of titania-silica interface. International Journal of Quantum Chemistry, 2018. 118 (4): p. e25495.
[26] R. Kitamura, L. P., M. Jonasz, Optical constants of silica glass from extreme ultraviolet to far infrared at near room temperature. Applied Optics, 2007. 46 (33).
[27] R. N. Evans, S.R.C., J.R. Brescia, J. W. Cleary, E. M. Smith, R. E. Peale, Far-infrared bands in plasmonic absorbers optimized for long-wave infrared. MRS Advances, 2019.
[28] D. Sadrid and A. Challener, Modern Introduction to Surface Plasmons: Theory, Mathematica Modeling, and Applications. 2010: Cambridge university Press.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. An ultra-spectrally selective terahertz (THz) band stop reflector, the reflector comprising:
a first layer of the reflector, the first layer of the reflector comprising a plurality of layers each including a substrate, a top coating, and a bottom coating;
a top layer of the plurality of layers, the top layer of the plurality of layers including an absence region of the top coating having a first area; and
a bottom layer of the plurality of layers, the bottom layer of the plurality of layers comprising an absence region of the top coating having a second area, the first area being greater than the second area, thereby enhancing a tuning capacity for attenuation of the THz bands therethrough.

2. The reflector of claim 1, wherein the reflector is configured to inhibit the reflectance of electromagnetic radiation in the THz frequency range between 0.1 THz and 10 THz.

3. The reflector of claim 1, further comprising a substrate having a thickness measured from the top surface to the bottom surface of between 10 nm and 1 mm.

4. The reflector of claim 3, further comprising a top coating being an absorber layer having high conductivity and including a conductive element disposed thereon.

5. The reflector of claim 4, wherein the top coating is applied to a top surface of the substrate.

6. The reflector of claim 5, wherein the conductive element includes a conductive region that is surrounded by an absence region.

7. The reflector of claim 6, wherein the absence region is configured to enable the propagation of THz bands therethrough.

8. The reflector of claim 5, further comprising a bottom coating, wherein the bottom coating is a backplane layer having high conductivity.

9. The reflector of claim 8, wherein the bottom coating is applied to a bottom surface of the substrate, the bottom surface of the substrate being opposite the top surface of the substrate.

10. The reflector of claim 6, the conductive region of the absorber layer is shaped as a cross having two perpendicularly intersecting sections that are equal in area and that each intersect at a midpoint of an opposing intersecting section.

11. The reflector of claim 10, wherein a width of each of the two perpendicularly intersecting sections is between 2 μm and 4.5 μm.

12. The reflector of claim 6, wherein a width of the defined absence region surrounding the conductive element is between 2.5 μm and 4 μm.

13. The reflector of claim 4, wherein the absorber layer includes a plurality of conductive elements disposed thereon.

14. The reflector of claim 10, wherein each conductive region of the plurality of conductive elements is shaped as a cross having two perpendicularly intersecting sections that are equal in area and that each intersect at a midpoint of an opposing intersecting section.

15. A method of using an ultra-spectrally selective terahertz (THz) band stop reflector, the method comprising:
providing the reflector comprising:
a first layer of the reflector, the first layer comprising a plurality of layers each including a substrate, a top coating, and a bottom coating;
a top layer of the plurality of layers, the top layer including an absence region of the top coating having a first area; and
a bottom layer of the plurality of layers, the bottom layer comprising an absence region of the top coating having a second area, the first area being greater than the second area; and
directing incident THz radiation toward the reflector to attenuate one or more selected THz frequency components.

16. The method of claim 15, wherein each top coating comprises an absorber layer including a conductive region surrounded by the absence region.

17. The method of claim 16, wherein the conductive region is shaped as a cross comprising two perpendicularly intersecting sections that are equal in area.

18. A method of manufacturing an ultra-spectrally selective terahertz (THz) band stop reflector, the method comprising:
forming a plurality of layers, each layer including a substrate, a top coating, and a bottom coating;
patterning the top coating of each layer to include an absence region;
assembling the plurality of layers into a first layer of the reflector such that:
a top layer of the plurality of layers includes an absence region of the top coating having a first area; and
a bottom layer of the plurality of layers includes an absence region of the top coating having a second area, the first area being greater than the second area, thereby enhancing a tuning capacity for attenuation of THz bands therethrough.

19. The method of claim 18, wherein patterning the top coating comprises forming a conductive region surrounded by the absence region using contact photolithography.

20. The method of claim 19, wherein each coating is deposited to a thickness of approximately 100 nm using electron beam evaporation.
